(19) United States
(12) Patent Application Publication
(10) Pub. No.: US 2010/0239883 A1
(43) Pub. Date: Sep. 23, 2010

(54) High Performance Thermal Spray Coated Polymer Substrates and Related Methods of Manufacture

(75) Inventors: Steve Okladek, Orefield, PA (US); Kerry Drake, Red Hill, PA (US); David Somerville, Broken Arrow, OK (US)

Correspondence Address: FLASTER/GREENBERG P.C.;Four Penn Center, 1600 John F. Kennedy Boulevard, 2nd Floor, PHILADELPHIA, PA, 19103, US

(73) Assignee: Greene, Tweed of Delaware, Inc., Wilmington, DE (US)

(21) Appl. No.: 12/702,839

(22) Filed: Feb. 9, 2010

Related U.S. Application Data
(60) Provisional application No. 61/151,554, filed on Feb. 11, 2009.

(51) Int. Cl. B32B 7/02; C23C 4/06; C23C 4/08; C23C 4/10; C23C 4/12; B32B 15/00; B32B 15/08

(52) U.S. Cl. 428/626; 427/455; 427/456; 427/450; 427/451; 428/615; 428/217

(57) ABSTRACT

Described are methods of coating a polymer substrate including thermal coating substrate with a metallic boundary material to form a first layer and thermal coating the first layer with a metallic thermal spray material to form a second layer. Related coated articles, coated members, actuators and other items are also included.

### CROSS REFERENCE TO RELATED APPLICATIONS

This patent application claims the benefit under 35 U.S.C. §119(e) of U.S. provisional patent application No. 61/151,554, filed Feb. 11, 2009, the disclosure of which is incorporated herein by reference.

### BACKGROUND OF THE INVENTION

Many component parts used in, for example, aerospace, aviation, semi-conductor processing and other industrial applications, must be able to function effectively under conditions of severe temperature and/or severe pressure, often in corrosive environments. In most cases, in addition to being able to endure these harsh conditions, most parts must also meet certain physical or mechanical specifications to fulfill their function. Particularly desirable in most applications is relatively high mechanical strength.

Conventionally, because of these dual requirements, many parts are fabricated from inert metal. Such metals are usually of high density so that a given component part may be contributing significant additional mass to the finished product or application. This becomes significant as any additional mass contributes to increased transports costs (or the part and the finished product). Additionally, in certain end applications such as jets, satellites, cars, and movable equipment, additional mass increases the costs associated with operating the applications.

Efforts have been made to coat composite materials with inert metal coatings so that the weight of the overall component part is reduced but the part remains resistant to the environmental stressors of high temperature, pressure and/or chemical attack. However, prior art attempts have resulted in coatings that are discontinuous, exhibit cracks, and/or have poor adherence to the underlying composite material. In some cases it has been found that the processes of applying the coating of inert metal to the composite actually degrades mechanical properties of the underlying composite, making the component part entirely useless even before it is inserted in the application.

Accordingly, there is a need in the art for materials that are lightweight but have a coating of a metallic material that is able to withstand extremes of temperature, pressure and/or chemical attacks, and methods of producing these materials.

### BRIEF SUMMARY OF THE INVENTION

Included in the scope of the invention are methods of coating a polymer substrate. The methods include thermal coating the substrate with a metallic boundary material to form a first layer and thermal coating the first layer with a metallic thermal spray material to form a second layer. The boundary material has a Rockwell hardness value that is less than a Rockwell hardness value of the thermal spray material. The method may include application of additional and/or intervening layers.

The invention also includes coated articles prepared by the methods described herein, including, for example, a coated article that includes a polymer substrate. The polymer substrate comprises a thermoplastic material. The thermoplastic material may be chosen from a polyether ketone (PEEK), a polyaryletherketone (PAEK), polyetherketone (PEK), polyetherketone ketone (PEKK), nylon, polyamideimide, polyimide, polysulfone, polyphenylsulfone, polyethersulfone and co-polymers thereof. The polymer substrate is coated with a coating that comprises at least two layers. The first layer includes a metallic boundary material and the second layer comprises a thermal spray material. The boundary material has a Rockwell hardness that is less than the Rockwell hardness of the thermal spray material.

Also included within the invention are coated members, actuators, and other articles that include the coated article described above.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is schematic representation of the coating process using an expansion nozzle; and

FIG. 2 is a schematic representation of a coated article of the invention shown in cross section at high magnification.

### DETAILED DESCRIPTION OF THE INVENTION

The invention described herein includes methods of coating a polymer substrate, the coated articles that are produced and specific devices, components and/or apparatuses that include that coated articles. The resulted coated articles exhibit resistance to delamination and permit use of components fabricated primarily out of high strength, lightweight, easily moldable or machinable polymer in chemically, mechanically, and/or thermally aggressive environments.

Included in the invention are methods of coating polymer substrates. The polymer substrates may be any known or to be developed in the art. Suitable polymers may include thermoplastic and/or thermoset polymers and copolymers of the same, especially those that perform well at high temperatures. Examples include, but are not limited to, polymers and copolymers of polyetheretherketone (PEEK), polyaryletherketone (PAEK), polyetherkeotne (PEK), polyether ketoneketone (PEKK), nylons, polyamideimide, polyimides, polysulphone, polyphenyl sulfone, polyimide, bismalimide, and polyethersulfone.

The polymer substrate may be made of neat polymer/copolymer or may be made of polymer combined with fillers, reinforcing materials, other polymers, and the like. For example, fillers which may be incorporated into substrate include, but are not limited to, glass (spheres or fibers), silicates, fiberglass, calcium sulfate, asbestos, boron fibers, ceramic fibers, polyamide fibers (such as those sold under the trademark KEVLAR., available from E.I. du Pont de Nemours & Co., 1007 Market Street, Wilmington, Del., 19898, U.S.A.), aluminum hydroxide, barium sulfate, calcium carbonate, magnesium carbonate, silica, alumina, aluminum nitride, borax (sodium borate), activated carbon, pearlite, zinc terephthalate, Buckeyballs, graphite, talc, mica, Hectorite, silicon carbide platelets, wollastonite, calcium terephthalate, silicon carbide whiskers, or fullerene tubes, depending on the specific properties desired in the end product. In some embodiments, it may be preferred that the polymer substrate contains carbon fibers (including chopped and/or continuous fibers), carbon whiskers, carbon balls or carbon nanotubes.

As is apparent to a person of ordinary skill in the art, the amount of filler present in the composition of the present invention may vary depending on several factors, including type of filler selected, grade or type of polymer used, presence or absence of an additional blending polymer(s), or additives and/or any specifically desired properties of the end product. However, in general, the filler in the polymer substrate may be present in the amount of about 1% to 80% by weight, about 5% to about 35% by weight, or, more preferably about 20% to about 30% by weight.

The polymer substrate may additionally or alternatively contain other polymers and co-polymers blended with the primary polymer. Such polymers (“blending polymers”) include any known in the art or to be developed which are useful to improve the processability or other properties, such as molten viscosity, mold flow, processability, insulative capacity, and other mechanical and/or electrical properties, without significantly degrading its thermal and/or chemical stability. More specifically, useful blending polymers include, without limitation, polyetherketone (PEK), polyetheretherketone (PEEK), polysulfones (PSU), polyether sulfones (PES), polyetherimides (PEI), polyphenylene sulfides (PPS), polyphthalamide (PPA), thermoplastic polyimide (TPI), polysulfone/polycarbonate alloy (PSU/PC), and/or liquid crystalline polymers (LCPs) (assuming the selected blending polymer is not the primary polymer).

In an embodiment, it may be preferred that the polymer substrate has a Rockwell M hardness of about 70 to about 120, or about 100 (as determined by ASTM D 785); a tensile yield strength of about 10,000 psi to about 20,000 psi or about 15,000 psi (as determined by ASTM D638); a Flexural strength of about 20,000 to about 30,000 psi, or about 25,000 psi (as determined by ASTM D790); and/or a coefficient of thermal expansion (<300° F.) of about 5.5×10-6/F.°. Each of the listed ASTMs are attached hereto as Appendix A and are incorporated herein by reference.

While those of ordinary skill in the art will appreciate that the amount of blending polymer present in the composition will vary depending on the properties desired, it is generally preferred that the blending polymer is present in an amount of about 2% by weight to about 50% by weight, with a more preferred amount of about 5% by weight to about 15% by weight and a most preferred amount of about 7% by weight to about 10% by weight of the total composition.

Additives may be incorporated into polymer substrate if desired. Such additives can include, for example, lubricating agents, thixtropic agents, UV-stabilizers, antistatic agents, viscosity-reducing agent, and/or flame retardants.

The polymer substrate is coated with at least two layers (described in detail below). When forming the layers, either or both of the first layer (including of boundary material) and/or the second layer (including thermal spray material) may be applied to the substrate by thermal spray process. Any thermal spray process may be used. Generally, a thermal spray processes are those involving use of an energy source to heat the selected coating material to a molten or semi-molten state and is propelling as it particles to the substrate surface by either process gases or jets. Thermal spray processes which may be suitable for use in the methods described herein include, without limitation, cold spray, electric arc spraying, plasma spraying (atmospheric pressure or vacuum), flame spraying, powder flame spraying, wire flame spraying and detonation gun processes. Preferred in an embodiment may be the high velocity oxygen fuel (HVOF) process, in which a fuel gas, such as, for example, hydrogen, propane, or propylene combined with oxygen, is used to create a combustion jet at high temperatures (about 2000 to about 3100° C.).

The layers may be independently applied by any processes known or to be developed in the art. For example, one may use sol-gel, slurry, dip, electroplate or other processes. In an embodiment, it may be desirable that both the first layer and the second layer (and any other layers of the coating if present) are applied by HVOF. By way of example the coating process may be carried out by preparing the substrate for mechanical bonding of the coating layers, applying a boundary or first layer of HVOF coating of a softer alloy material which will not abrade the substrate. This will be applied in layers at a specific feed rate, temperature, and offset distance, until minimum of about 0.007″ to about 0.002″ thickness of coating is generated. This forms a boundary layer acceptable to have the top coat or second coating of Tugsten-Carbide-Colbalt-Chrome (WC—Co—Cr) apply with good mechanical bonding to the first layer. In an embodiment, an additional minimum thickness of 0.007″ tr about 0.003″ of material may be applied in the same layered method.

Prior to depositing the first layer, it may be desirable to subject the surface of the polymer substrate to a surface treatment to alter the surface topography. For example, it may be desirable to polish, sand, grit blast, etch (using, e.g., solvents or acids), brush and/or buff the surfaces of the polymer substrate prior to depositing the first layer of the coating. Similarly, one may wish to subject the surface of the first deposited layer to one or more surface treatments prior to deposition of the second layer.

The polymer substrate has a coating, which contains at least two layers, referred to herein as a “first” layer and a “second” layer. (Other layers, if desired, may be present in an embodiment, so long as the “first layer” is adjacent to the composite polymer and the second layer is the exterior most layer). Both the first layer and the second layer comprise metallic materials, in an embodiment, preferably malleable metallic materials. In an embodiment the first layer (which includes the boundary material) has a Rockwell hardness that is less than the corresponding value of the second layer (which includes the thermal spray material).

The interface of the layers may be a discrete boundary or it may be gradientized interface whereby the layers transition gradually from one material to another. Alternatively, it may be partially gradientized and partially discrete.

It may be preferred that the boundary material has a Rockwell hardness (Rockwell 15N) of about 70 or about 80 to about 85 or about 95, about 75 or about 85 to about 80 or about 90, or about 79 or about 89 to about 82 or about 92. In an embodiment, the boundary material has a Rockwell hardness of about 90. It may be preferred that the thermal spray layer has Rockwell hardness (Rockwell 15N) of about 80 or about 90 to about 100 or about 110; about 81 or about 91 to about 95 or about 105, or about 83 or about 93 to about 87 or about 97.

In some embodiments, it may be preferred that the difference between the Rockwell hardness value of the boundary material and the Rockwell hardness value of the thermal spray material is a difference of about 10, about 9, about 8, about 7, about 6, about 5, about 4, about 3, about 2 or about 1. Alternatively, the Rockwell hardness value of the boundary material may be about 0.5 times (0.5×) to about 1.5 times (1.5×) the Rockwell hardness value of the thermal spray material.

For example, in an embodiment, it may be desirable that the Rockwell hardness value of the boundary material is about 90 (Rockwell 15N) and the value of the thermal spray material is about 93 to about 97 (Rockwell 15N).

In an embodiment, the boundary material may have an apparent density of about 0.1 to about 0.3 lbs/cu-in, about 0.15 to about 0.25, or about 0.155 lbs/cu-in.

The coating overall, as well each of the individual layers, may be continuous or discontinuous, and may be any thickness desired. In an embodiment, the thickness of the coating overall may be about 7 to about 14 mils or no greater than about 0.020 inches.

The first layer of the coating includes a metallic boundary material. The boundary material is preferably an austenitic alloy, such as an austenitic nickel-based alloy, nickel-iron-chromium alloys, and/or nickel-chromium based alloy containing amounts of one or more of aluminum, zirconium, nitrogen, cobalt, molybdenum, and/or niobium. Preferably, these alloys are super alloy, i.e., capable of maintaining mechanical strength and creep resistance at high temperatures. It may be preferred that the selected boundary material includes super alloys available under the trade name INCONEL® (Special Metals Corporation, Huntington, N.Y.) or PRAXAIR® (available from Praxair Surface Technologies, Inc. Indianapolis, Ind.). It may be preferred that the first layer includes INCONEL 718, PRAXAIR NI-202 and/or PRAXAIR NI-357-1.

The thickness of the first layer containing the boundary material may be about 6 mils to about 8 mils. The coating on the polymer substrate also includes a second layer that is formed from materials including a thermal spray material. In an embodiment, the thermal spray material is preferably a metallic (including cermets). It may include, for example, tungsten carbide, tungsten carbide/cobalt, tungsten carbide/chromium, tungsten carbide/cobalt/chromium, tungsten carbide/chromium/nickel, tungsten carbide/nickel/chromium/boron/silicon. In an embodiment, tungsten carbide/cobalt/chromium may be preferred, with a cobalt content of about 10% to about 20% and a chromium content of about 7% to about 15%.

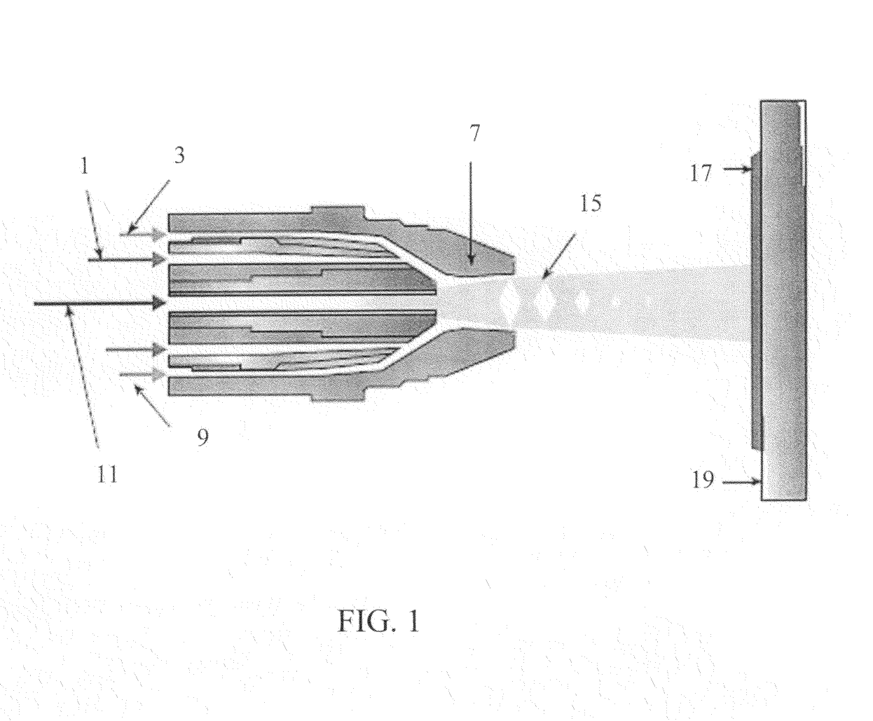

FIG. 1 shows an exemplary schematic ‘snapshot’ of a step in the coating process. Fuel gas (1), oxygen (3), and compressed air (9) are channeled through several channels (5) in the expansion nozzle (7) of the sprayer. Coating powder (carried by a carrier gas) (11) is conveyed through a central channel (13). Diamond shockwaves (15) are produced at the end of the nozzle, and an coating (17) is formed on the workpiece (19).

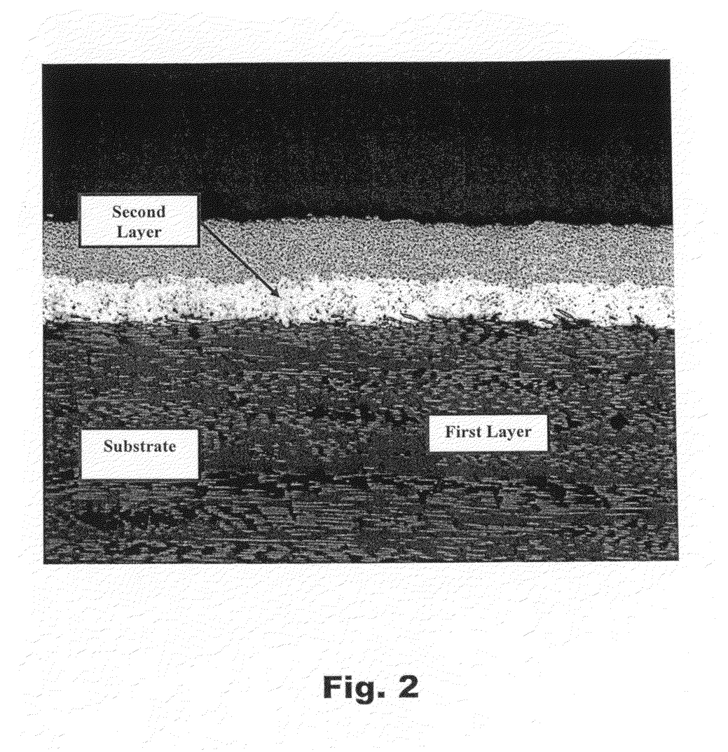

FIG. 2 shows a schematic representation of a coated polymer substrate (21) in accordance with the invention. The polymer substrate (23) is coated with a first layer (25) of boundary material and a second layer (27) of a metallic thermal spray material.

Also included with in the scope of the invention are parts, components, articles, pieces and the like that are prepared by the above-described methods and/or have the structures of the above-descried coated articles. In an embodiment, it maybe desirable that the article is an actuator. Other embodiments may include parts or components for aerospace applications, manufacturing applications (e.g., metal coating lines or other metal processing operations, food processing, medical or pharmaceutical processing); automotive applications; and semiconductor fabrications.

### Example 1

### Preparation of a Coated Substrate

A coated substrate was prepared using HVOF. First, a tubular sample of polymer substrate measuring approximately 2″ in diameter, 6″ in length and having a wall thickness of about 0.25″, was prepared.

The surface of the tubular section was grit blasted preparation for coating. A boundary layer in INCONEL® 718 (Praxair NI-202) was applied using a HVOF process in a sweeping motion to build a 0.007″ layer of boundary material. A second layer, made of Tungsten-Carbide-Cobalt-Chrome WC—Co—Cr (H.C. Stark Amperit® 553) was applied using the same method in a depth of 0.007″. Finally, the second layer was polished to a finish of 2 μin Ra.

The sample with subjected to 10 cycles of thermal cycle testing consisting of: Placing sample in an environmental chamber @ 275° F. for 1 hour; Removing, visual inspecting, the placing into a second environmental chamber at a temperature of −65° F. for 1 hour, and Removing and re-inspecting for fractures, inclusions, and de-lamination of the coated material. This process was repeated nine additional times.

### Example 2

### Evaluation of Bond Strength of Boundary Layer to Substrate

Ten samples of coated substrate prepared as described above in a configuration of 2″×2″×0.25″ wall with an ID curvature radius of 26″, were tested using the protocol of ASTM C-633-01, attached hereto in Appendix A and incorporated herein by reference. Specifically, samples were coated with a single coating layer of INCONEL® 718. Ten samples were made and inspected visually. The five best visual samples were retained from testing; the remainders were discarded.

Two threaded aluminum dowels measuring 1.0″ in diameter and 2″ in length were affixed to the center of the surface of the sample: the first to the OD coated surface and the second to the uncoated ID surface. They were bonded using an epoxy resin with a known bond strength of greater than 10,000 psi. After allowing the epoxy resin to cure for two hours, the coated sample was placed in an Inston pull testing machine. The Instron pulls at a predetermined rate of 0.4″ per minute and measures the force induced in the pull effort. Test results indicated an average adhesion strength of approximately 1000 psi.

It will be appreciated by those skilled in the art that changes could be made to the embodiments described without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of coating a polymer substrate comprising:
a. coating the substrate with a metallic boundary material to form a first layer; and
b. coating the boundary layer with a metallic thermal spray material to form a second layer;
wherein the boundary material has a Rockwell hardness value that is less than a Rockwell hardness value of the thermal spray material.

2. The method of claim 1, wherein at least one of steps (a) or (b) comprises thermally coating using a high velocity thermal spray process.

3. The method of claim 1, wherein the high velocity thermal spray process is a high velocity oxygen fuel spray process.

4. The method of claim 1, wherein a difference between the Rockwell hardness value of the boundary material and the Rockwell hardness value of the thermal spray material is chosen from about 10, about 9, about 8, about 7, about 6, about 5, and about 4 to about 3.

5. The method of claim 1, wherein the boundary material has a coefficient of thermal expansion that is about 0.5× to about 1.5× of the coefficient of thermal expansion of the polymer substrate at ambient temperature.

6. The method of claim 1, wherein the polymer substrate has a coefficient of thermal expansion that remains substantially stable over a range of temperatures.

7. The method of claim 6, wherein the coefficient of thermal expansion of the polymer substrate is substantially aligned with the coefficient of thermal expansion of the thermal spray material over the temperature range.

8. The method of claim 1, wherein the polymer substrate comprises a thermoplastic material, a thermoset material and mixtures thereof.

9. The method of claim wherein the polymer substrate comprises a material chosen from polyetheretherketone (PEEK), polyaryletherketone (PAEK), polyetherkeotne (PEK), polyether ketoneketone (PEKK), nylons, polyamideimide, polyimides, polysulphone, polyphenyl sulfone, polyethersulfone, and copolymers thereof.

10. The method of claim 1, wherein the polymer substrate further comprises a carbon material chosen from a carbon ball, a carbon whisker, a carbon tube, a carbon nanotube, a carbon fiber and mixtures thereof.

11. The method of claim 1, wherein the polymer substrate further comprises a material chosen from glass (spheres or fibers), silicates, fiberglass, calcium sulfate, asbestos, boron fibers, ceramic fibers, polyamide fibers, aluminum hydroxide, barium sulfate, calcium carbonate, magnesium carbonate, silica, alumina, aluminum nitride, borax (sodium borate), activated carbon, pearlite, zinc terephthalate, Buckeyballs, graphite, talc, mica, synthetic Hectorite, silicon carbide platelets, wollastonite, calcium terephthalate, silicon carbide whiskers, fullerene tubes and mixtures thereof.

12. The method of claim 1 wherein the material is present in an amount of about 1% to about 80% by weight of the total composite.

13. The method of claim 1, wherein the boundary material comprises a metallic material chosen from an austenitic nickel-based alloy, a nickel-iron-chromium alloy, a nickel-chromium-based alloy, a nickel-chromium-aluminum alloy, a nickel-chromium-zirconium alloy, a nickel-chromium-cobalt alloy, a nickel-chromium-molybdenum alloy, a nickel-chromium-niobium alloy, and mixtures thereof.

14. The method of claim 1 wherein the first layer has a thickness of about 6 mils to about 8 mils.

15. The method of claim 1, wherein the thermal spray material comprises tungsten carbide.

16. The method of claim 1 wherein the thermal spray material comprises at least one of tungsten carbide, tungsten carbide cobalt, tungsten cobalt chromium, and nickel aluminide.

17. The method of claim 1, wherein the second layer formed has a thickness of about 7 mils to about 10 mils.

18. The method claim 1, wherein the method further comprises applying a surface treatment prior to at least one of step (a) or step (b).

19. The method of claim 18, wherein the method further comprises applying a surface treatment prior to at least one of step (a).

20. The method of claim 18, wherein the surface treatment is chosen from at least one of polishing; cleaning; acid washing; sanding; grit blasting; brushing; and buffing.

21. A coated article prepared by the method of claim 1.

22. A coated article comprising a polymer substrate comprising a thermoplastic material chosen from a polyetheretherketone (PEEK), polyaryletherketone (PAEK), polyetherketone (PEK), polyether ketoneketone (PEKK), nylons, polyamideimide, polyimides, polysulphone, polyphenyl sulfone, polyethersulfone, and copolymers thereof that is coated with a coating comprising at least two layers, wherein the first layer comprises a boundary material and the second layer comprises a thermal spray material, and the boundary material has a Rockwell hardness that is less than a Rockwell hardness of the thermal spray material.

23. The coated article of claim 22, wherein at least one of the at least two layers is applied by a thermal spray process.

24. The coated article of claim 23, wherein the thermal spray process is a high velocity oxygen thermal spray process.

25. The coated article of claim 22, wherein the polymer substrate has a coefficient of thermal expansion that remains substantially stable over a range of temperature.

27. The coated article of claim 22, wherein the coefficient of thermal expansion of the polymer substrate is substantially aligned with the coefficient of thermal expansion of the thermal spray material over a temperature range.

28. The coated article of claim 22, wherein the boundary material comprises a metallic material chosen from an austenitic nickel-based alloy, a nickel-iron-chromium alloy, a nickel-chromium-based alloy, a nickel-chromium-aluminum alloy, a nickel-chromium-zirconium alloy, a nickel-chromium-cobalt alloy, a nickel-chromium-molybdenum alloy, a nickel-chromium-niobium alloy, and mixtures thereof.

29. The coated article of claim 22, wherein the first layer has a thickness of about 6 mils to about 8 mils.

30. The coated article of claim 22, wherein the thermal spray material comprises tungsten carbide.

31. The coated article of claim 22, wherein the thermal spray material comprises at least one of tungsten carbide, tungsten carbide cobalt, nickel aluminide, and tungsten cobalt chromium.

32. The coated article of claim 22, wherein the second layer formed has a thickness of about 7 mils to about 10 mils.

34. A drive member for use as an actuator comprising the coated article of claim 19.
